(19) United States
(12) Patent Application Publication
(10) Pub. No.: US 2024/0195340 A1
(43) Pub. Date: Jun. 13, 2024

(54) POWER SUPPLY SYSTEM SUPPLYING AN ELECTRICAL LOAD VIA A POLYPHASE VOLTAGE AND AN AUXILIARY NETWORK VIA A HOMOPOLAR COMPONENT OF THE VOLTAGE, AND RELATED ELECTRICAL INSTALLATION

(71) Applicant: Commissariat à l'énergie atomique et aux énergies alternatives, Paris (FR)

(72) Inventors: Ghislain DESPESSE, GRENOBLE CEDEX 9 (FR); Jérôme BLATTER, GRENOBLE CEDEX 9 (FR)

(21) Appl. No.: 18/534,493

(22) Filed: Dec. 8, 2023

(30) Foreign Application Priority Data
Dec. 9, 2022 (FR) 2213081

(51) Int. Cl. H02P 27/06; B60L 15/00; H02J 7/00; H02P 25/022

(52) U.S. Cl. CPC H02P 27/06; B60L 15/007; H02J 7/0063; H02P 25/022; B60L 2210/30

(57) ABSTRACT

A power supply system includes a main power supply system generating, from a main network, at least one polyphase voltage for supplying at least one load. Each load includes a winding for each phase. The windings are connected in star connection at a midpoint. An auxiliary power supply system of an auxiliary network includes a first power supply terminal and a second power supply terminal. The main power supply system is configured to generate the at least one polyphase voltage with at least one non-zero homopolar component. The auxiliary power supply system includes a module for connecting the first power supply terminal to the midpoint and the second power supply terminal to a reference point, for supplying the auxiliary network via at least one homopolar component coming from the midpoint.

### CROSS-REFERENCE TO RELATED APPLICATIONS

This application is a U.S. non-provisional application claiming the benefit of French Application No. 22 13081, filed on Dec. 9, 2022, which is incorporated herein by reference in its entirety.

### FIELD

The present invention relates to a power supply system comprising a main system for supplying at least one electrical load, via at least one polyphase voltage and from a main electrical network; and an auxiliary system for supplying an auxiliary electrical network.

The invention also relates to an electrical installation comprising the at least one electrical load, the main electrical network, and such an electrical power supply system.

The invention relates to the field of power supply to auxiliary electrical networks, in particular DC auxiliary networks on-board vehicles, for which the direct supply voltage to be supplied is typically less than or equal to 48 V. The DC voltage of the auxiliary network is e.g. generally on the order of 12 to 14 V when the vehicle is a car, and on the order of 24 to 28 V when the vehicle is a truck.

The invention further relates to the field of electric traction transport, and of energy conversion for variable speed electric motors, the main power supply system being typically connected to the main battery of an electric vehicle, said battery forming the main electrical network. The main electrical network is typically a DC electrical network with a DC voltage on the order of 400 V, or even on the order of 800 V, or more generally any DC voltage with a value much higher than the voltage of the auxiliary electrical network. The ratio between the maximum voltage of the main electrical network and the maximum voltage of the auxiliary electrical network is typically greater than four.

### BACKGROUND

At present, an auxiliary electrical network of an electric vehicle is generally supplied from a DC bus supplied by the main battery of the vehicle, via a DC-DC converter, arranged between the DC bus and the auxiliary network. The DC-DC converter then converts the DC voltage from the DC bus to a much lower voltage, such as a voltage on the order of 12 V or 24 V, for supplying the auxiliary network. In addition to adjusting voltage and current, the DC-DC converter is sometimes used for providing a galvanic isolation between the DC bus and the auxiliary network. The DC-DC converter is generally independent of an electrical power supply system of the electric motor of the vehicle.

An alternative solution to the aforementioned general solution is described in document WO 2013/110649 A2, and consists in positioning a conversion system between the motor supply system and the electric motor as such, the power supply system being typically formed by a voltage inverter apt to convert the DC voltage of the DC bus into an AC voltage supplying the electric motor which is then an AC motor, typically a three-phase motor. The conversion system is then configured to convert the AC voltage from the voltage inverter into the DC voltage supplying the auxiliary network.

However, such a conversion system requires a plurality of converters for drawing a balanced power on the three phases of the three-phase motor supply voltage, a respective converter being connected to each phase at the output of the voltage inverter.

### SUMMARY

The goal of the invention is then to propose an electrical power supply system for supplying the auxiliary electrical network in an easier way, while not disturbing the supply of the at least one electrical load.

To this end, the subject matter of the invention is an electrical power supply system comprising:
a main electrical power supply system configured to generate, from a main electrical network, at least one polyphase voltage in order to supply at least one electrical load;
the or each electrical load having a winding for each phase of the respective polyphase voltage, the windings being connected together at a midpoint in a star connection;
an auxiliary power supply system configured to supply an auxiliary power network, the auxiliary electrical network including a first and a second power terminal;
the main power supply system being configured to generate the at least one polyphase voltage with at least one non-zero homopolar component, and
the auxiliary power supply system comprising a connection module configured to connect the first power supply terminal to the midpoint and the second power supply terminal to a reference point, for supplying the auxiliary electrical network via the at least one non-zero homopolar component, the respective homopolar component coming from the midpoint.

With the supply system according to the invention, the connection module of the auxiliary power supply system can then be used for supplying the auxiliary network in an easy way by connecting the first supply terminal of the auxiliary network to the midpoint so as to recover the at least one non-zero homopolar component of the polyphase voltage coming from said midpoint and generated by the main power supply; and by connecting the second auxiliary power supply terminal to the reference point.

In other words, the power supply system according to the invention can be used for supplying the auxiliary network in an easy way, by generating the at least one polyphase voltage supplying the at least one electrical load, such as an electric motor, so as to have the at least one non-zero homopolar component; then by cleverly exploiting the at least one non-zero homopolar component for supplying the auxiliary network.

In other words, a person skilled in the art would observe that the at least one polyphase voltage generated by the main power supply system makes it possible to supply both the at least one electrical load and the auxiliary network, the at least one electrical load being supplied directly with the at least one polyphase voltage, and the auxiliary network being supplied indirectly with said at least one polyphase voltage, namely via the connection module so as to exploit the at least one non-zero homopolar component.

According to other advantageous aspects of the invention, the power supply system comprises one or a plurality of the following features, taken individually or according to all technically possible combinations:
the main power supply system is configured to generate a first, and a second, polyphase voltage respectively in order to supply a first, and a second electrical load, respectively, the windings of the first load being connected in a star connection at a first midpoint and the windings of the second load being connected in star connection at a second midpoint, the main power supply system being configured to generate the first polyphase voltage with a first homopolar component, and to generate the second polyphase voltage with a second homopolar component, at least one of the first and second homopolar components being non-zero,
the connection module is then configured to connect the first power supply terminal to the first midpoint and the second power supply terminal to the second midpoint, the second midpoint forming the reference point, for supplying the auxiliary electrical network via the first homopolar component coming from the first midpoint and via the second homopolar component coming from the second midpoint;
the reference point is a point substantially midway between potentials supplied by the main electrical network;
the substantially midway point preferably having as its potential an average of the potentials supplied by the main electrical network at plus or minus 30% of the maximum potential among said supplied potentials;
the auxiliary electrical network is a DC electrical network;
the DC supply voltage of the auxiliary electrical network being preferentially comprised between 12 V and 48 V;
the or each homopolar component generated by the main power supply is a DC component, and the connection module is configured to directly connect the first power supply terminal to the midpoint and the second power supply terminal to the reference point;
the homopolar component or each homopolar component generated by the main power supply system is an AC component, and the connection module comprises a rectifier suitable for converting the or each homopolar alternating component into a direct voltage delivered to the auxiliary electrical network;
the rectifier preferentially including a diode bridge; and
the auxiliary power supply system further comprises an electrical isolation module connected to the output of the connection module and intended to be connected at the input of the auxiliary electrical network, the electrical insulation module comprising an electrical transformer with at least one primary winding and at least one secondary winding, an auxiliary inverter connected to the primary winding(s) and an auxiliary rectifier connected to the secondary winding(s).

The invention further relates to an electrical installation comprising at least one electrical load, a main electrical network and a power supply system,
the power supply system being as defined hereinabove; the main power supply system being connected between the main electrical network and the at least one electrical load for supplying same with the at least one generated polyphase voltage; the or each electrical load including a winding for each phase of the respective polyphase voltage, the windings being connected together at a midpoint, in a star connection.

According to other advantageous aspects of the invention, the electric installation comprises one or a plurality of the following features, taken individually or according to all technically possible combinations:
the main power supply is configured to generate the polyphase voltage with an alternating homopolar component;
the main power supply system being preferentially configured to generate the polyphase voltage with the AC homopolar component having a voltage or current of zero mean value over a time period;
the time period being still preferably a period of the polyphase voltage or a time portion of a discharge cycle of the main electrical network when the main electrical network is in form of a battery; the time portion being for example selected from: a predefined duration of a few minutes, a half discharge cycle and the discharge cycle—the main power supply system is configured to generate the polyphase voltage with the AC homopolar component by using at least one harmonic component of rank 3 for increasing the peak value of the voltage supplying the load;
the main electrical network is a DC network apt to supply a DC voltage, and the main power supply system is configured to convert said DC voltage into the polyphase voltage;
the main electrical network includes a plurality of DC elementary sources, and the main power supply comprises a plurality of single-phase inverters, each connected to a respective DC elementary source;
the reference point being preferentially connected to a terminal of a respective DC elementary source;
the reference point being preferentially still connected to a terminal common to the DC elementary sources;
the main electrical network includes a plurality of DC elementary sources, and the main power supply includes a dynamic reconfiguration module suitable for generating the polyphase voltage via a dynamic reconfiguration of the DC elementary sources;
the reference point being preferentially connected to a terminal of a respective DC elementary source;
the reference point being preferentially still connected to a terminal common to the DC elementary sources;
the main electrical network includes a single DC source, and the main power supply includes a polyphase inverter apt to generate the polyphase voltage from said DC source;
the reference point being preferentially connected to a terminal of the DC source;
the or each homopolar component is an AC component; the DC source includes a set of a plurality of DC cells, such as battery cells, connected in series; and wherein the connection module includes a first diode and a second diode, connected to a group of certain DC cells of the assembly, the group having first and second ends, the first diode being connected by the cathode thereof to the first end and by the anode thereof to the midpoint so as to receive the or each homopolar component; the second diode being connected by the anode thereof to the second end and by the cathode thereof to the midpoint so as to receive the or each homopolar component; and the connection module being further configured to connect the first power terminal to the first end and the second power terminal to the second end;
the reference point being preferentially connected to a terminal of a respective DC cell;
the or each electrical load is an electric motor including a rotor and a stator, the windings connected in a star connection being the stator windings;
the electric motor being in particular a synchronous motor with a wound rotor, called wound excitation, and the auxiliary power supply system being then preferentially configured to additionally supply the wound rotor of the synchronous motor; and
the polyphase voltage includes P phases, P being an integer greater than or equal to 3.

### BRIEF DESCRIPTION OF THE DRAWINGS

Such features and advantages of the invention will become clearer upon reading the following description, given only as a non-limiting example, and made with reference to the enclosed drawings, wherein:

FIG. 1 is a schematic representation of an electrical installation according to the invention, comprising an electrical load apt to be supplied with a polyphase voltage and including a winding for each phase of the polyphase voltage; a main electrical network; a main system for the electrical supply of the electrical load from said main network; and an auxiliary power supply system for an auxiliary electrical network including a first and a second power supply terminal, the auxiliary system including a module for connecting said first and second terminals for supplying the auxiliary electrical network via a non-zero homopolar component of the polyphase voltage;

FIG. 2 is a view similar to the view of FIG. 1, when the main power supply is configured to supply a plurality of electrical loads, more particularly first and second electrical loads;

FIG. 3 is a view representing a first set of voltage curves for the different phases of the polyphase voltage supplied by the main system, a second set of curves representing the voltages at the terminals of the windings of the electrical load, as well as a curve representative of a homopolar component of the polyphase voltage, according to a first example;

FIG. 4 is a view similar to the view shown in FIG. 3, according to second and third examples.

FIG. 5 is a view similar to the view shown in FIG. 3 according to fourth and fifth examples.

FIG. 6 is a schematic representation of the connection module, depending on whether the homopolar component is a DC or an AC component.

FIG. 7 is a schematic representation of two embodiments of the main power supply system when the system is configured to provide a polyphase voltage for supplying at least one electrical load;

FIG. 8 is a view similar to the view of FIG. 7, when the main system is configured to supply a plurality of polyphase voltages to supply a plurality of electrical loads, more particularly the first and second electrical loads;

FIG. 9 is a schematic representation of an example of the connection module when the homopolar component is an AC component and the main electrical network includes a single DC source consisting of a plurality of DC cells connected in series;

FIG. 10 is a schematic representation of the auxiliary electrical power supply system when the system further comprises an electrical isolation module connected between the connection module and the auxiliary network;

FIG. 11 is a schematic representation of an example of embodiment where the electrical load is a synchronous motor with wound excitation and the auxiliary system is suitable for supplying the wound excitation of the synchronous motor; and

FIG. 12 is a schematic representation of a further example of the main power supply device and the main electrical network.

### DETAILED DESCRIPTION

Hereinafter in the description, the expression “substantially equal to” and “on the order of” define a relation of equality within plus or minus 20%, preferentially still within plus or minus 10%, preferentially still within plus or minus 5%.

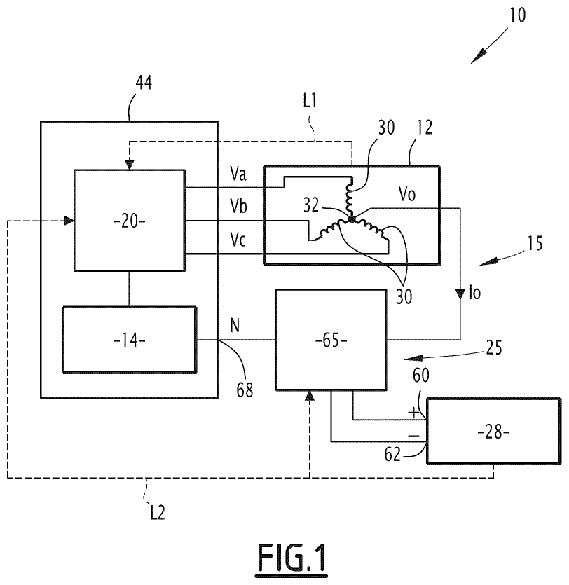

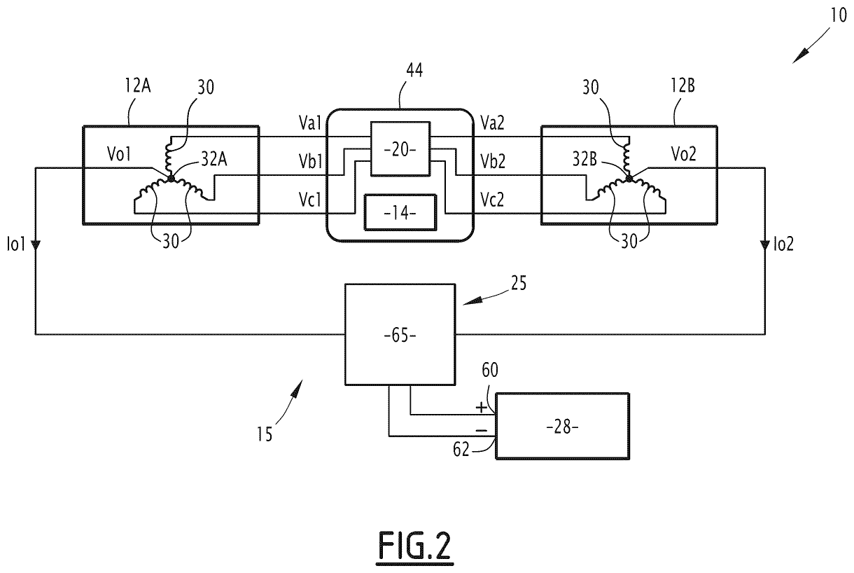

In FIGS. 1 and 2, an electrical installation 10 comprises at least one electrical load 12, a main electrical network 14 and an electrical supply system 15, the electrical supply system 15 including a main system 20 for supplying electrical power to the at least one electrical load 12 from the main electrical network 14 and an auxiliary system 25 for supplying electrical power to an auxiliary electrical network 28.

As an optional supplement, the electrical installation 10 comprises a first loop-back link L1 between the at least one electrical load 12 and the main power supply system 20, hereinafter referred to as the main power supply system 20, the first loop-back link L1 being used for transmitting information from the at least one electrical load 12 to the main power supply system 20 for a regulation of the power supply of the at least one electrical load 12.

As a further optional supplement, the electrical installation 10 comprises a second loop-back link L2 between the auxiliary electrical network 28 and the main power supply system 20 on the one hand, and the auxiliary power supply system 25 on the other hand, the second loop-back link L2 being used for the transmission of information from the auxiliary electrical network 28 to the main power supply system 20 and to the auxiliary electrical power supply system 25, hereinafter called the auxiliary power supply system 25, for a regulation of the power supply of the auxiliary electrical network 28.

In the example shown in FIG. 1, the electric installation 10 comprises only one electrical load 12.

In the example shown in FIG. 2, the electrical installation 10 comprises a plurality of electrical loads 12, in particular two electrical loads 12, namely a first electrical load 12A and a second electrical load 12B.

The or each electrical load 12 is configured to be supplied with a separate polyphase voltage supplied by the main power supply system 20. The or each electrical load 12 includes a winding 30 for each phase of the polyphase voltage, the windings 30 being connected to each other at a midpoint 32, according to a star connection, i.e. according to a star connection, or else according to a star coupling.

In the example shown in FIG. 2, the windings of the first load 12A are connected in a star connection at a first midpoint 32A, and the windings of the second load 12B are connected in a star connection at a second midpoint 32B.

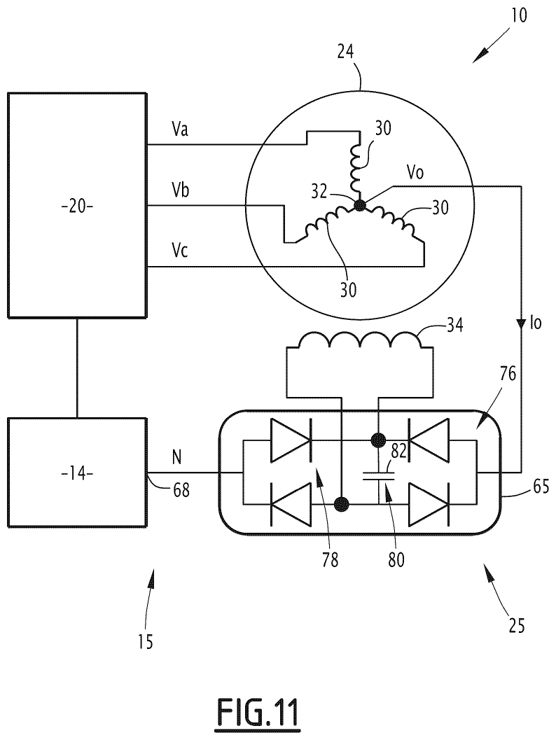

The or each electrical load 12 is e.g. an electric motor including, as is known per se, a rotor and a stator (not shown). The windings 30 connected in a star connection are then typically the stator windings. The electric motor is an asynchronous motor, or a synchronous motor as in the example shown in FIG. 11.

In the example shown in FIG. 11, the electrical load 12 is in particular a synchronous motor with a wound rotor 34, also called a wound excitation, the wound excitation 34 needing to be supplied with power in order to start the synchronous motor.

The main electrical network 14 is typically a DC network apt to supply a DC voltage. The DC voltage of the main electrical network 14 is e.g. on the order of 400 V, or again on the order of 800 V, or more generally a voltage of much higher value than the voltage of the auxiliary electrical network 28. The ratio between the maximum voltage of the main electrical network 14 and the maximum voltage of the auxiliary electrical network 28 is typically greater than four.

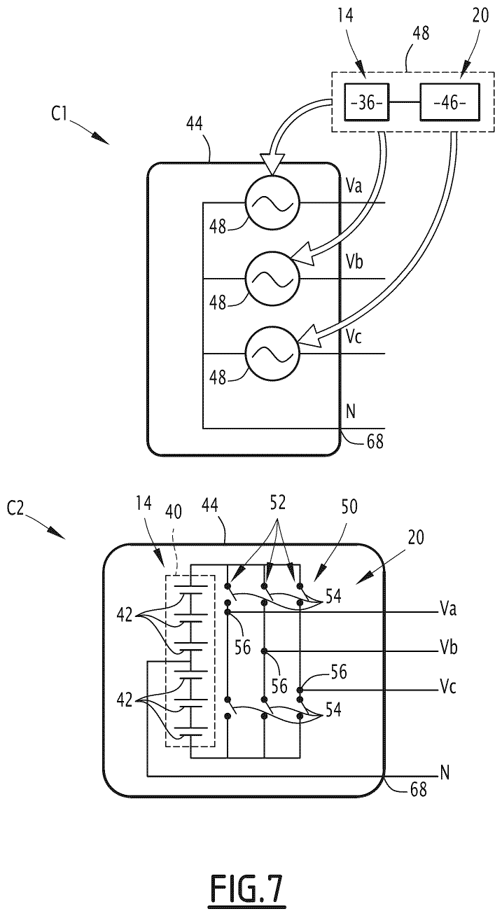

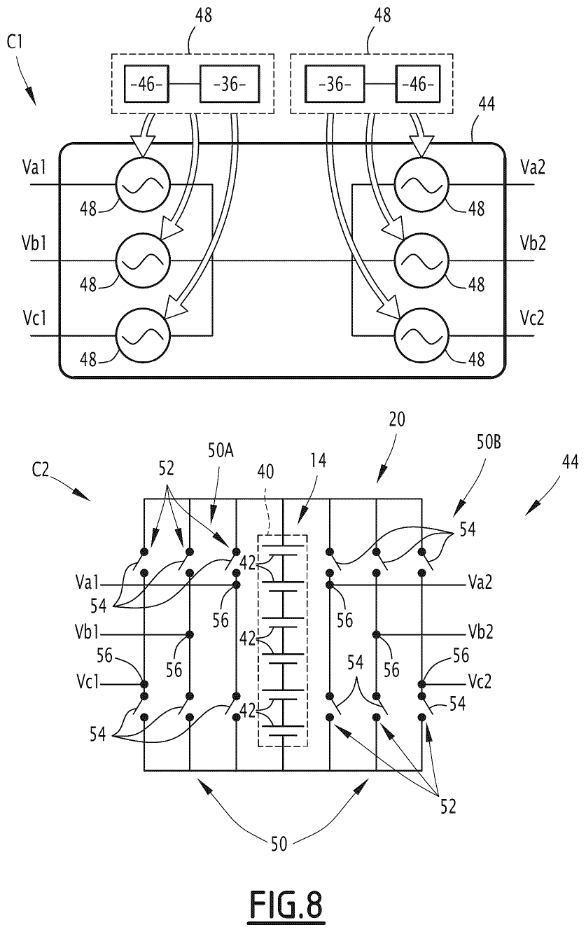

In the examples shown in FIGS. 7 and 8, according to a first configuration C1, the main electrical network 14 includes a plurality of DC elementary sources 36, each typically then making the generation of a respective phase of the polyphase voltage possible.

In the examples shown in FIGS. 7 and 8, according to a second configuration C2, the main electrical network 14 includes a single DC source 40, consisting e.g. of a set of a plurality of DC cells 42, such as battery cells, connected in series.

The electrical power supply system 15 is configured to supply both the at least one electrical load 12 and the auxiliary electrical network 28, from the main electrical network 14. The electrical supply system 15 then comprises the main supply system 20 for power supply to the at least one electrical load 12 and the auxiliary supply system 25 for power supply to the auxiliary network 28.

The main power supply system 20 is configured to generate, from the main electrical network 14, at least one polyphase voltage in order to supply the at least one electrical load 12. The or each polyphase voltage includes P phases, P being an integer greater than or equal to 3.

The main power supply system 20 and the main electrical network 14 form a main power supply assembly 44, as shown in FIGS. 1 and 2.

According to the invention, the main power supply system 20 is configured to generate the at least one polyphase voltage with at least one non-zero homopolar component.

In the example shown in FIG. 1, the polyphase voltage is a three-phase voltage, and the voltages of each of the three phases are denoted by Va, Vb, Vc, respectively. The voltage of the homopolar component is denoted by Vo, and the current thereof is denoted by Io.

In the example shown in FIG. 2, the main power supply system 20 is configured to generate a first, and a second polyphase voltage respectively in order to supply the first 12A, and the second 12B, electrical charge respectively. The first polyphase voltage and the second polyphase voltage are each a three-phase voltage; and the voltages of each of the three phases of the first polyphase voltage are denoted by Va1, Vb1, Vc1, respectively, the voltages of each of the three phases of the second polyphase voltage being denoted by Va2, Vb2, Vc2, respectively.

In the example shown in FIG. 2, the main power supply system 20 is configured to generate the first polyphase voltage with a first homopolar component, and to generate the second polyphase voltage with a second homopolar component, at least one of the first and second homopolar components being non-zero. The voltage of the first homopolar component is denoted by Vo1, and its current is denoted by Io1. The voltage of the second homopolar component is denoted by Vo2, and the current thereof is denoted by lo2.

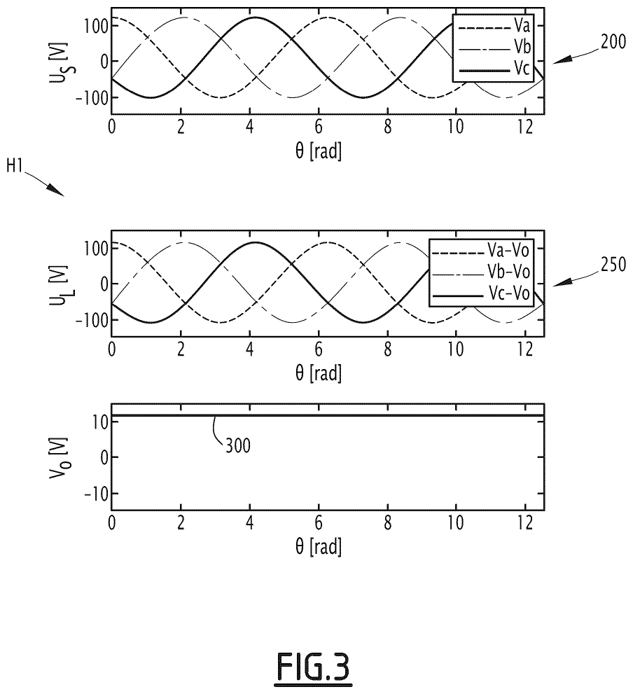

In the example shown in FIG. 3, the main power supply system 20 is configured to generate the polyphase voltage with a DC homopolar component. FIG. 3 then shows a first set 200 of voltage curves for the different phases of the polyphase voltage supplied by the main system 20, a second set 250 of curves representing the voltages at the terminals of the windings 30 of the electrical load 12, as well as a curve 300 representative of the homopolar component of the polyphase voltage, according to a first example H1 where the homopolar component is a DC component.

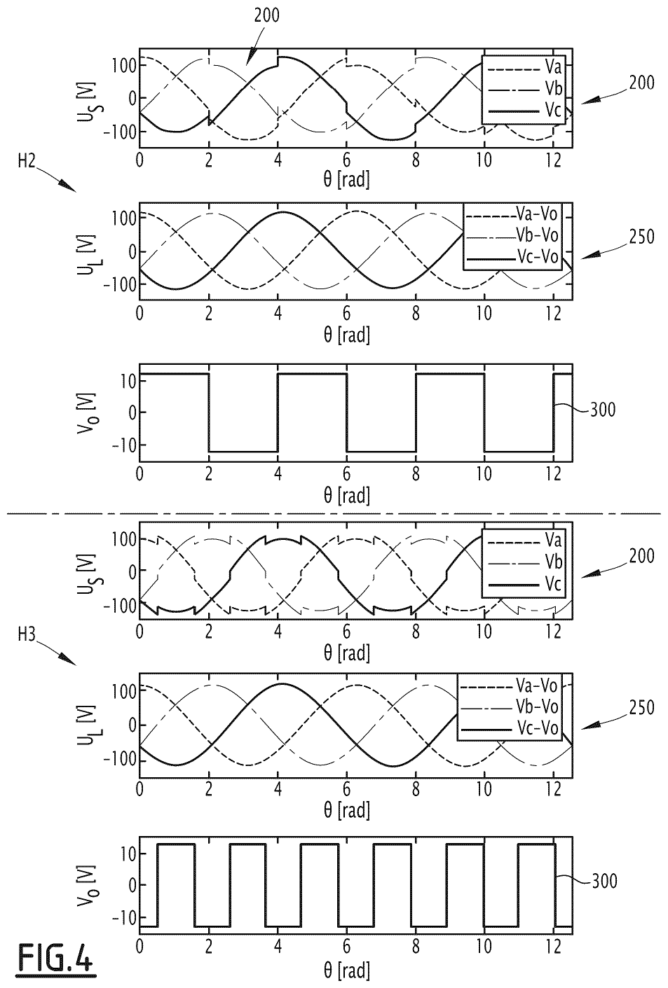

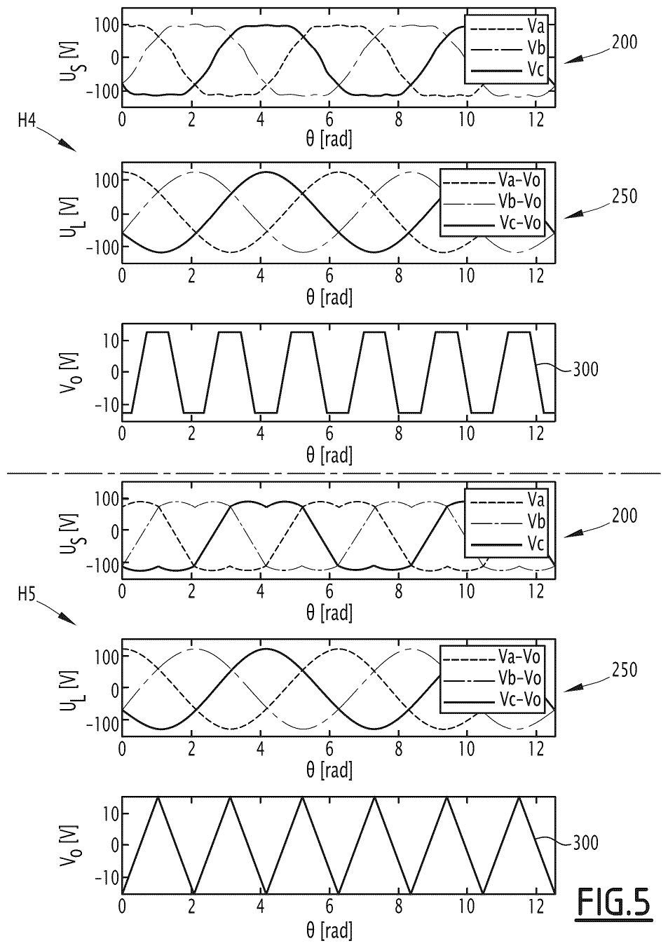

In the example shown in FIG. 3, as well as in the subsequent examples of FIGS. 4 and 5, the polyphase voltage corresponds to the voltage U_{S}, the voltage across the windings 30 of the electrical load 12 corresponds to the voltage U_{L}, and the voltage of the homopolar component corresponds to the voltage Vo, each of the voltages being expressed in volts (V). Each of the voltages is periodic, and the curves of said voltages are then a function of an angular phase θ expressed in radians (rad), on the abscissa.

In the examples shown in FIGS. 4 and 5, the main power supply system 20 is configured to generate the polyphase voltage with an AC homopolar component. The examples in FIGS. 4 and 5 then show the first set 200 of voltage curves for the different phases of the polyphase voltage, the second set 250 of curves representative of the voltages across the windings 30 of the electrical load 12, as well as the curve 300 representative of the homopolar component of the polyphase voltage, according to different successive examples where the homopolar component is an AC component, namely according to a second example H2, a third example H3, a fourth example H4 and a fifth example H5.

In the examples in FIGS. 4 and 5, the main power supply system 20 is advantageously configured to generate the polyphase voltage with the AC homopolar component having a voltage of zero mean value during a period of the polyphase voltage. According to the second example H2 or the third example H3, the AC homopolar component is in the form of a rectangular signal of zero mean value. According to the fourth example H4, the AC homopolar component is in the form of a trapezoidal signal of zero mean value. According to the fifth example H5, the AC homopolar component is in the form of a triangular signal of zero mean value.

According to the third example H3, the fourth example H4 and the fifth example H5, the AC homopolar component has a zero mean value and is, furthermore, at a frequency which is a multiple of the frequency of the polyphase voltage, in order to limit the maximum voltage to be supplied by the main power supply system 20 with respect to a neutral point N of the main electrical network 14, without having an impact on the differential voltages across the electrical load 12.

According to the third example H3, the fourth example H4 and the fifth example H5, the main power supply system 20 is configured to generate the polyphase voltage with an AC homopolar component having a fundamental component three times the frequency of the polyphase voltage, so as to increase the peak value of the differential voltages across the terminals of the electrical load 12. The injection of a third harmonic is known in the prior art e.g. under the name “Third Harmonic Injection”.

When the main electrical network 14 is a DC network apt to supply a DC voltage, the main power supply system 20 is configured to convert said DC voltage into the polyphase voltage.

When the main electrical network 14 includes a plurality of elementary DC sources 36 according to the first configuration C1 of the examples shown in FIGS. 7 and 8, the main power supply system 20 includes e.g. a plurality of single-phase inverters 46, each single-phase inverter 46 being connected to a respective elementary DC source 36. Each respective elementary DC source 36 then forms, with the respective single-phase inverter 46 which is connected thereto at output, a respective single-phase source 48. In other words, the pair of a DC elementary source 36 and a respective single-phase inverter 46 connected at the output thereof forms a respective single-phase source 48.

In the example shown in FIG. 7, the main power supply system 20 is configured to generate a single polyphase voltage, such as a three-phase voltage, and the main power supply system 20 then includes P single-phase inverters 46 according to the example of the first configuration C1, where P is the number of phases of the polyphase voltage. In other words, in the example of the first configuration C1 shown in FIG. 7, the main power supply assembly 44 includes P single-phase sources 48.

In the example shown in FIG. 8, the main power supply 20 is configured to generate the first polyphase voltage and the second polyphase voltage, each being e.g. a three-phase voltage, and the main power supply system 20 then comprises 2*P single-phase inverters 46 according to said example of the first configuration C1, where P represents the number of phases of each polyphase voltage. In other words, according to the example of the first configuration C1 in FIG. 8, the main power supply assembly 44 includes 2*P single-phase sources 48.

When the main electrical network 14 includes a plurality of DC elementary sources 36 according to the first configuration C1 of the examples shown in FIGS. 7 and 8, the main power supply system 20 includes, in a variant, a dynamic reconfiguration module (not shown), the dynamic reconfiguration module being configured to generate the polyphase voltage via a dynamic reconfiguration of the DC elementary sources 36. Such a dynamic reconfiguration module is described in document WO 2013/110649 A2 or in documents U.S. Pat. No. 10,044,069 B2 and US 2014/287278 A1. Such a dynamic reconfiguration module typically includes switches forming switching bridges, such as H-bridges, in order to generate the polyphase voltage from the DC elementary sources 36. As an example, the dynamic reconfiguration module is described in document U.S. Pat. No. 10,044,069 B2 with reference to FIGS. 38 and 39, in the third and fourth paragraphs of column 31, where the switches of the switching bridges are identified by the numbers 86 to 89. In the example shown in FIGS. 38 and 39 of the document U.S. Pat. No. 10,044,069 B2, the three DC elementary sources are identified by the number 116, and along with the dynamic reconfiguration module, the sources then form a complete three-phase system, i.e. a three-phase network, the main electrical network 14 then being said three-phase network; the dynamic reconfiguration module comprising the switching bridges with the switches identified by the numbers 86 to 89, as described hereinabove.

According to the variant of the first configuration C1, when the main power supply system 20 is configured to generate a single polyphase voltage, as in the example shown in FIG. 7, the main power supply system 20 includes only one dynamic reconfiguration module.

According to said variant of the first configuration C1, when the main power supply system 20 is configured to generate a plurality of polyphase voltages, such as the first polyphase voltage and the second polyphase voltage, as in the example shown in FIG. 8, the main power supply system 20 preferentially comprises a plurality of dynamic reconfiguration modules, namely a dynamic reconfiguration module for each polyphase voltage to be generated.

When the main electrical network 14 includes a single DC source 40 according to the second configuration C2 of the examples in FIGS. 7 and 8, the main power supply system 20 typically includes a polyphase inverter 50 apt to generate the polyphase voltage from said DC source 40. The main power supply system 20 typically includes a polyphase inverter 50 for each polyphase voltage to be generated.

In the example shown in FIG. 7, the main power supply system 20 is configured to generate a single polyphase voltage, such as a three-phase voltage, and the main power supply system 20 includes only one polyphase inverter 50 according to the example of the second configuration C2 shown in FIG. 7.

In the example shown in FIG. 8, the main power supply 20 is configured to generate two polyphase voltages, namely the first polyphase voltage and the second polyphase voltage, and the main power supply system 20 includes two polyphase inverters 50 according to the example of the second configuration C2 shown in FIG. 8, namely a first polyphase inverter 50A for generating the first polyphase voltage and a second polyphase inverter 50B for generating the second polyphase voltage.

As is known per se, each polyphase inverter 50 typically includes P switching branches 52, i.e. a switching branch 52 for each phase of the polyphase voltage to be generated, and each switching branch 52 includes two switches 54 connected in series and to each other at an intermediate point 56, at which the corresponding phase of the polyphase voltage is delivered.

The auxiliary electrical power supply system 25 is configured to supply the auxiliary electrical network 28, the auxiliary electrical network 28 including a first power supply terminal 60 and a second power supply terminal 62.

According to the invention, the auxiliary power supply system 25 comprises a module 65 for connecting the first power supply terminal 60 to the midpoint 32 and the second power supply terminal 62 to a reference point 68, such as the neutral point N of the main network 14, also called a neutral point N.

As an optional supplement, the auxiliary power supply system 25 comprises an electrical isolation module 70 connected to the output of the connection module 65 and intended to be connected at the input of the auxiliary electrical network 28.

The auxiliary electrical network 28 is a DC network capable apt to supply a DC voltage. The DC supply voltage of the auxiliary electrical network 28 is typically less than or equal to 48 V, and preferentially comprised between 12 V and 48 V. The DC voltage of the auxiliary network is e.g. generally on the order of 12 V when the vehicle on which the electrical installation 10 is apt to be taken on board is a car, and on the order of 24 to 28 V when said vehicle is a truck.

The DC voltage of the auxiliary electrical network 28 is more generally a voltage of much lower value than the voltage of the main electrical network 14. The ratio between the maximum voltage of the auxiliary electrical network 28 and the maximum voltage of the main electrical network 14 is typically less than one quarter.

The first supply terminal 60 is e.g. a terminal of positive polarity, and the second supply terminal 62 is e.g. a terminal of negative polarity.

The connection module 65 is configured to connect the first power supply terminal 60 to the midpoint 32 and the second power supply terminal 62 to the reference point 68, in order to supply the auxiliary electrical network 28 via the at least one non-zero homopolar component, the respective homopolar component coming from the midpoint 32.

In the example shown in FIG. 2, the main power supply 20 is configured to generate two polyphase voltages, namely the first polyphase voltage and the second polyphase voltage, and the connection module 65 is then configured to connect the first power supply terminal 60 to the first midpoint 32A and the second power supply terminal 62 to the second midpoint 32B, the second midpoint 32B forming the reference point 68, for supplying the auxiliary electrical network 28 via the first homopolar component coming from the first midpoint 32A and via the second homopolar component coming from the second midpoint 32B.

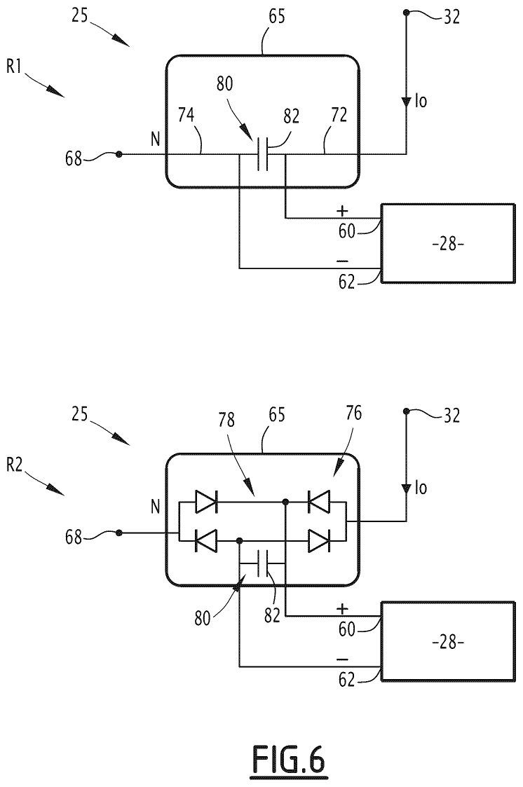

When the or each homopolar component generated by the main power supply system 20 is a DC component, the connection module 65 is typically configured to directly connect the first power supply terminal 60 to the midpoint 32, and directly the second power supply terminal 62 to the reference point 68, respectively, as shown in a first example of connection R1 in FIG. 6.

In the first example of connection R1, the connection module 65 then comprises a first link 72 for connecting the midpoint 32 to the first power supply terminal 60, and a second link 74 for connecting the reference point 68 to the second power supply terminal 62.

When the or each homopolar component generated by the main power supply system 20 is an AC component, the connection module 65 includes a rectifier 76 suitable for converting the or each alternating homopolar component into a DC voltage delivered to the auxiliary electrical network 28, as shown in a second example of connection R2 in FIG. 6. The rectifier 76 includes e.g. a diode bridge 78. In a variant, the rectifier 76 is an active rectifier, including, as is known per se, controllable switches, such as transistors, in particular insulated gate field-effect transistors, also called MOSFETs (Metal Oxide Semiconductor Field Effect Transistor).

A person skilled in the art would observe that the connection module 65 is then configured to connect the first supply terminal 60 to the midpoint 32, and the second supply terminal 62 to the reference point 68, respectively, directly when the homopolar component generated by the main power supply system 20 is a DC component, and indirectly, typically via the rectifier 76, when the homopolar component generated by the main power supply system 20 is an AC component.

As an optional supplement, both to the first example of connection R1 where the homopolar component is a DC component and to the second example of connection R2 where the homopolar component is an AC component, the connection module 65 further includes a capacitive element 80, the capacitive element 80 being apt to be connected between the first supply terminal 60 and the second supply terminal 62. The capacitive element 80 limits the voltage ripples at the input of the auxiliary electrical network 28. The capacitive element 80 is e.g. a capacitor 82 and/or an auxiliary battery (not shown).

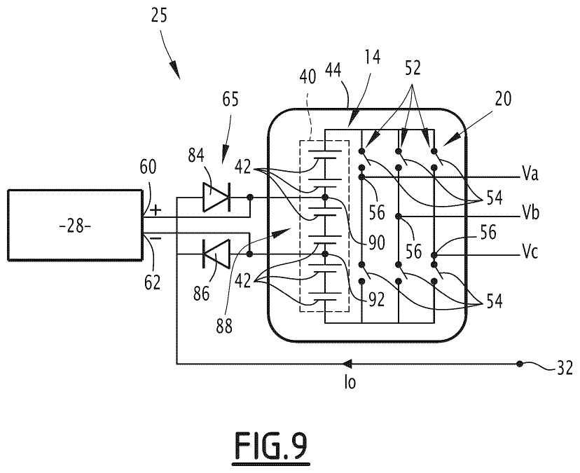

In a variant of the second example of connection R, when the or each homopolar component is an AC component and the DC source 40 includes a set of a plurality of DC cells 42, such as battery cells, connected in series, the connection module 65 includes a first diode 84 and a second diode 86, connected to a group 88 of certain DC cells 42 of the assembly, the group 88 having first 90 and second 92 ends, as shown in FIG. 9. The first diode 84 is then e.g. connected by the cathode thereof to the first end 90 and by the anode thereof to the midpoint 32 in order to receive the or each homopolar component. The second diode 86 is then e.g. connected by the anode thereof to the second end 92 and by the cathode thereof to the midpoint 32 in order to receive the or each homopolar component. The connection module 65 is further configured to connect the first power supply terminal 60 to the first end 90 and the second power supply terminal 62 to the second end 92.

Such variant makes it possible to share part of the DC cells 42 between the DC source 40 of the main electrical network 14 and the DC power supply of the auxiliary electrical network 28. Such variant then makes it possible e.g. to have auxiliary battery of 12 or 24 V less on-board an electric vehicle, when the electrical supply system 15 is on-board the vehicle.

The reference point 68 is e.g. connected to a terminal of a respective elementary DC source 36. In the example shown in FIG. 7 according to the first configuration C1, the DC elementary sources 36 are connected to one another at a common terminal, and the reference point 68 is then advantageously connected to said terminal common to the DC elementary sources 36.

In a variant, the reference point 68 is e.g. connected to a terminal of the DC source 40. In the example shown in FIG. 7 according to the second configuration C2, the single DC source 40 consists of a set of a plurality of DC cells 42, and the reference point 68 is then advantageously connected to a terminal of a respective DC cell 42, the reference point 68 being typically a point between two of the DC cells 42.

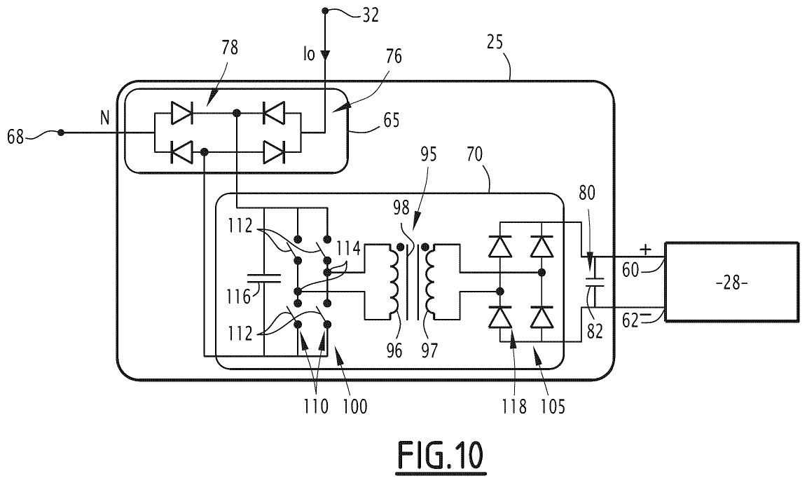

As an optional supplement, the electrical isolation module 70 includes e.g. an electrical transformer 95 with at least one primary winding 96 and at least one secondary winding 97 wound around a magnetic core 98, as shown in FIG. 10.

According to the optional supplement, the electrical isolation module 70 then typically further includes an auxiliary inverter 100 connected to the primary winding(s) 96 and an auxiliary rectifier 105 connected to the secondary winding(s) 97.

In the example shown in FIG. 10, the auxiliary inverter 100 includes two auxiliary switching branches 110, i.e. an auxiliary switching branch 110 for each polarity of the DC voltage coming from the connection module 65, the auxiliary inverter 100 being connected at the output of the connection module 65, such as at the output of the rectifier 76. Each auxiliary switching branch 110 includes two auxiliary switches 112 connected in series and to each other at an intermediate point 114, at which the corresponding phase of the AC voltage from the auxiliary inverter 100 is delivered to the primary winding 96.

In addition, the auxiliary inverter 100 includes a filtering capacitor 116 connected in parallel with the auxiliary switching branches 110 and upstream thereof, the filtering capacitor 16 being intended to filter the DC voltage coming from the connection module 65.

In the example shown in FIG. 10, the auxiliary rectifier 105 further includes an auxiliary diode bridge 118. The auxiliary diode bridge 118 is then connected between the secondary winding 97 and the auxiliary electrical network 28, or between the secondary winding 97 and the capacitive element 80 when the latter is present between the first and second supply terminals 60, 62 of the auxiliary electrical network 28.

In the example shown in FIG. 11, as indicated hereinabove, the electrical load 12 is in particular the synchronous motor with the wound excitation 34, and the auxiliary power supply system 25 is advantageously further suitable for supplying power to the wound excitation 34 of the synchronous motor. According to said example, the wound excitation 34 of the synchronous motor is then connected to the auxiliary power supply system 25, instead of the auxiliary power supply 28, or else in parallel with said auxiliary power supply 28.

In the example shown in FIG. 11, the connection module 65 is typically identical to the connection module 65 according to the second example of connection R2 shown in FIG. 6. The connection module 65 then includes e.g. the rectifier 76 in the form of the diode bridge 78 and the capacitive element 80 in the form of the capacitor 82, and the wound excitation 34 is connected to the terminals of the capacitive element 80.

Each of the switches 54 and of the auxiliary switches 112, or again of the switches of the rectifier 76 when the rectifier is active, is preferentially a one-way voltage switch. Each of said switches includes e.g. a transistor and an intrinsic diode antiparallel with the transistor. The transistor is e.g. an insulated gate field effect transistor, also called MOSFET (Metal Oxide Semiconductor Field Effect Transistor) or a bipolar transistor; or further a thyristor.

Thereby, the invention consists in controlling the polyphase voltage generated by the main power supply system 20 so as to have a non-zero homopolar component, and then in using said homopolar component for supplying power to the auxiliary electrical network 28.

A non-zero homopolar component refers to a homopolar component which is not constant at a zero value with respect to the reference point 68, where said AC homopolar component can nevertheless have a voltage of zero mean value over a period of the polyphase voltage. A person skilled in the art would understand that the homopolar component thereby obtained is not constantly zero, while same could have a zero mean value during the period of the polyphase voltage.

In other words, the electrical supply system 15 according to the invention is configured to supply both the at least one electrical load 12 via the polyphase voltage generated by the main supply system 20, and, furthermore, the auxiliary electrical network 28 via the auxiliary power supply system 25 exploiting the non-zero homopolar component associated with said polyphase voltage.

As a result, there is no need to use a power converter for supplying the auxiliary electrical network 28 from the main electrical network 14 with a much higher voltage than the voltage required for the auxiliary electrical network 28. Indeed, even when the homopolar component is an AC component, and the connection module 65 of the auxiliary power supply system 25 then includes the rectifier 76, such as the diode bridge 78, the rectifier 76 is a rectifier operating at low voltage and then requiring only low voltage components, such as the diodes of the diode bridge 78, and not high voltage components (>150 V).

Furthermore, when the at least one electrical load 12 is an electric motor, the inductance of the electric motor makes possible an efficient filtering of current or [voltage], which limits or eliminates the need for an additional inductance, compared with a DC-DC power converter from the prior art.

A person skilled in the art would also observe that the homopolar component which can controlled independently of the operation state of the load 12, such as the engine, and the main power supply system 20 is then suitable for controlling the value of the homopolar component independently of the operation state of the load 12. The term “operating state of the load” refers to an operating point of the load which requires at each instant a certain amplitude and a certain frequency of the polyphase voltage (or current). The operating point changes over time, e.g. as a function of a torque and a motor speed in the case of a polyphase motor load, which then requires a dynamic control of the amplitude and of the frequency of the polyphase supply voltage/current.

As a supplement, when the voltage or the current of the AC homopolar component is of zero mean value over the period of the polyphase voltage generated by the main power supply system 20, as a result, it is possible to maintain a better balance of the main electrical network 14, and in particular limits any risk of imbalance between a high part and a low part of the main electrical network 14 with respect to the reference point 68, such as the neutral point N.

Furthermore, when the main electrical network 14 includes a plurality of DC elementary sources 36 according to the first configuration C1 of the examples shown in FIGS. 7 and 8, a greater flexibility of implementation results therefrom, the DC elementary sources 36 being e.g. of a distinct type, such as batteries, capacitors or photovoltaic panels, and each of the phases of the polyphase voltage thereby has an energy storage and an associated single-phase inverter 46. Furthermore, a connection, in a star connection, of the three DC elementary sources 36, then forming with the single-phase inverters 46 connected thereto three single-phase sources 48, respectively, makes it possible to easily obtain the reference point 68, such as the neutral point N.

The reference point 68 refers to a point which can be different from the central point (neutral point N), more particularly if the number of DC cells 42 connected in series is an odd number, the reference point 68 being a point between two of the DC cells 42, and being then necessarily slightly offset with respect to the neutral point N. The homopolar component is determined with respect to the reference point 68.

As a supplement, when the auxiliary power supply system 25 includes the electrical isolation module 70, it is possible, as a result, to provide a galvanic isolation between the auxiliary electrical network 28 and the main electrical network 14. According to such supplement, when the electrical isolation module 70 includes the auxiliary inverter 100 upstream of the electrical transformer 95, it is possible, as a result, to increase the frequency of modulation of the voltage at the input of the transformer 95 and then to reduce the size of the latter. The auxiliary inverter 100 can also be used as a voltage step-down for obtaining a lower homopolar current at equal power, and thereby reduce losses by Joule effect, as well as a possible saturation in the electrical load 12, such as magnetic saturation in the motor when the electrical load 12 is a motor.

As an alternative to the zero mean voltage for the AC homopolar component, the AC homopolar component has a zero mean current over a period of time. In particular, the average current is substantially zero relative to the reference point 68, so as not to create an imbalance between a high and a low part of the main electrical network 14 relative to the reference point 68. This substantially zero mean, i.e. average, current is achieved by adjusting the proportion of time the homopolar component is positive or negative relative to reference point 68.

The average of the AC homopolar component is not necessarily calculated over the period of the polyphase voltage, and is more generally calculated for a given time period.

The time period is, for example, the period of the polyphase voltage, as described above.

Alternatively, the time period is a time portion of a discharge cycle of an electrical battery when it forms the main electrical network 14. The time period is then, for example, a predefined duration of a few minutes, a half-discharge cycle, or even the complete discharge cycle.

In the examples shown in FIGS. 4 and 5, the frequency of the homopolar component is equal to the frequency of the polyphase voltage or a multiple of this frequency. This is advantageous, particularly for maximizing the polyphase voltage amplitude.

Alternatively, the frequency of the homopolar component may be lower, e.g. in the order of Hz, tenths of Hz, or even hundredths of Hz, in particular to limit the frequency of the voltage on the connection module 65 or to facilitate polyphase voltage control.

According to this variant, when using the rectifier 76 in the form of the diode bridge 78, the use of a lower frequency in particular makes it possible to limit losses. This lower frequency also reduces high-frequency interference, which can be a problem in terms of electromagnetic compatibility, or EMC.

In the examples shown in FIG. 7, reference point 68 is a point substantially midway between potentials supplied by the main electrical network 14.

By “substantially midway point”, we typically mean a point whose potential is an average of the potentials supplied by the main electrical network 14, at plus or minus 30% of the maximum potential among said supplied potentials.

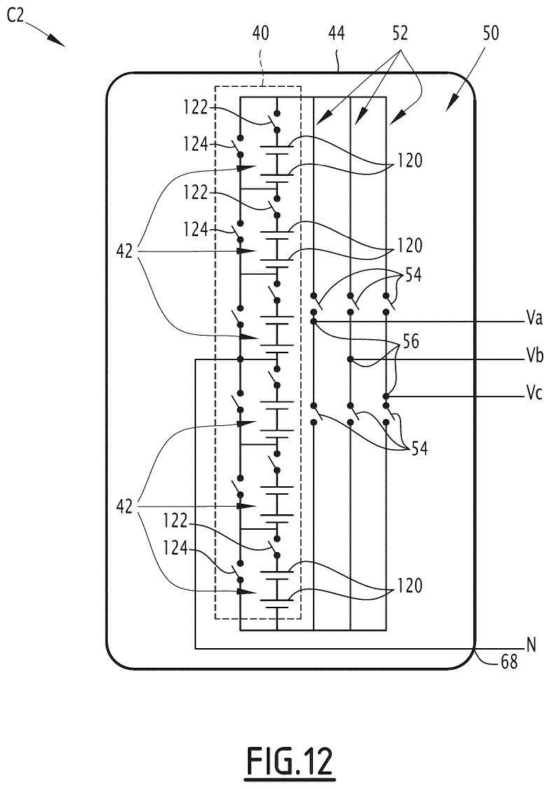

FIG. 12 illustrates another example of how the main supply device 20 and the main electrical network 14 form the main power supply assembly 44, where the reference point 68 is a point substantially midway between the potentials supplied by the main power network 14.

In the example shown in FIG. 12, and analogously to the second configuration C2 of the example shown in FIG. 7, the main electrical network 14 comprises the single DC source 40, formed by the assembly of several DC cells 42, such as battery cells, connected in series.

In the example shown in FIG. 12, each DC cell 42 then typically comprises one or more battery cells 120 connected in series with a primary switch 122, forming a series arrangement. Each DC cell 42 further comprises a secondary switch 124 connected in parallel with said series arrangement formed by the battery cell(s) 120 and the primary switch 122.

As is known per se, the primary 122 and secondary 124 switches then make it possible to manage a configuration of the battery cells 120 connected in series to form the DC source 40, and also the positioning of the reference point 68 with respect to the potentials supplied by the DC source 40 forming the main electrical network 14, i.e. to manage the positioning of the reference point 68 with respect to the potentials at the ends of the DC source 40.

In particular, the primary switches 122 and secondary switches 124 allow the reference point 68 to be slightly shifted with respect to the middle of the voltage delivered by the DC source 40. In other words, depending on the configuration of the DC source 40, and in particular on the open or closed position of the respective primary switches 122 and secondary switches 124, the reference point 68 is likely to be shifted down or up depending on the respective number of DC cells 42 connected in series below and above this reference point 68, thus conferring an additional degree of adjustment. This adjustment may also allow an increase in the voltage available on the auxiliary network 28, without increasing the value or amplitude of the homopolar component.

What is claimed is:

1. An electrical power supply system comprising:
a main electrical power supply system configured to generate, from a main electrical network, at least one polyphase voltage in order to supply at least one electrical load;
each electrical load having a winding for each phase of the respective polyphase voltage, the windings being connected together at a midpoint in a star connection;
an auxiliary power supply system configured to supply power to an auxiliary electrical network, the auxiliary electrical network including a first and a second power supply terminals;
wherein the main power supply system is configured to generate the at least one polyphase voltage with at least one non-zero homopolar component, and
the auxiliary power supply system comprises a connection module configured to connect the first power supply terminal to the midpoint and the second power supply terminal to a reference point, for supplying the auxiliary electrical network via the at least one non-zero homopolar component, the respective homopolar component coming from the midpoint.

2. The system according to claim 1, wherein the main power supply system is configured to generate a first, and a second, polyphase voltage, respectively, to supply a first, and a second, electrical load, respectively, the windings of the first load being connected in a star connection at a first midpoint and the windings of the second load being connected in a star connection at a second midpoint, the main power supply system being configured to generate the first polyphase voltage with a first homopolar component, and to generate the second polyphase voltage with a second homopolar component, at least one of the first and second homopolar components being non-zero,
wherein the connection module is then configured to connect the first supply terminal to the first midpoint and the second supply terminal to the second midpoint, the second midpoint forming the reference point, for supplying the auxiliary electrical network via the first homopolar component coming from the first midpoint and via the second homopolar component coming from the second midpoint.

3. The system according to claim 1, wherein the reference point is a point substantially midway between potentials supplied by the main electrical network.

4. The system according to claim 3, wherein the potential of the substantially midway point is an average of the potentials supplied by the main electrical network at plus or minus 30% of the maximum potential among said supplied potentials.

5. The system according to claim 1, wherein the auxiliary electrical network is a DC power network.

6. The system according to claim 5, wherein each homopolar component generated by the main power supply system is a DC component, and the connection module is configured to directly connect the first supply terminal to the midpoint and the second supply terminal to the reference point.

7. The system according to claim 5, wherein each homopolar component generated by the main power supply system is an AC component, and the connection module includes a rectifier suitable for converting each AC homopolar component into a DC voltage delivered to the auxiliary electrical network.

8. The system according to claim 1, wherein the auxiliary power supply system further comprises an electrical isolation module connected at the output of the connection module and intended to be connected at the input of the auxiliary electrical network, the electrical insulation module including an electrical transformer with at least one primary winding and at least one secondary winding, an auxiliary inverter connected to the primary winding(s) and an auxiliary rectifier connected to the secondary winding(s).

9. An electrical installation comprising at least one electrical load, a main electrical network and a power supply system,
wherein the power supply system is according to claim 1; the main power supply system being connected between the main electrical network and the at least one electrical load for supplying same with the at least one generated polyphase voltage; each electrical load including a winding for each phase of the respective polyphase voltage, the windings being connected to each other at a midpoint in a star connection.

10. The installation according to claim 9, wherein the main power supply system is configured to generate the polyphase voltage with an AC homopolar component.

11. The installation according to claim 10, wherein the main power supply system is configured to generate the polyphase voltage with the AC homopolar component having a voltage of zero mean value over a time period.

12. The installation according to claim 10, wherein the main power supply system is configured to generate the polyphase voltage with the AC homopolar component having a current of zero mean value over a time period.

13. The installation according to claim 11, wherein the time period is a period of the polyphase voltage.

14. The installation according to claim 11, wherein the time period is a time portion of a discharge cycle of the main electrical network when the main electrical network is in form of a battery.

15. The installation according to claim 14, wherein the time portion is selected from: a predefined duration of a few minutes, a half discharge cycle and the discharge cycle.

16. The installation according to claim 10, wherein the main power supply system is configured to generate the polyphase voltage with the AC homopolar component using at least one harmonic component of rank 3 for increasing the peak value of the voltage supplying the load.

17. The installation according to claim 9, wherein the main electrical network is a DC network apt to supply a DC voltage, and the main power supply system is configured to convert said DC voltage into the polyphase voltage.

18. The installation according to claim 17, wherein the main electrical network includes a plurality of DC elementary sources, and the main power supply system includes a plurality of single-phase inverters, each connected to a respective DC elementary source.

19. The installation according to claim 18, wherein the reference point is connected to a terminal of a respective DC elementary source.

20. The installation according to claim 18, wherein the reference point is connected to a terminal common to the DC elementary sources.

21. The installation according to claim 17, wherein the main electrical network includes a plurality of DC elementary sources, and the main power supply system includes a dynamic reconfiguration module suitable for generating the polyphase voltage via a dynamic reconfiguration of the DC elementary sources.

22. The installation according to claim 21, wherein the reference point is connected to a terminal of a respective DC elementary source.

23. The installation according to claim 21, wherein the reference point is connected to a terminal common to the DC elementary sources.

24. The installation according to claim 17, wherein the main electrical network includes a single DC source, and the main power supply system includes a polyphase inverter apt to generate the polyphase voltage from said DC source.

25. The installation according to claim 24, wherein the reference point being preferentially connected to a terminal of the DC source.

26. The installation according to claim 21, wherein each homopolar component is an AC component; the DC source includes a plurality of DC cells, connected in series; and wherein the connection module includes a first diode and a second diode, connected to a group of certain DC cells of the assembly, the group having first and second ends, the first diode being connected by the cathode thereof to the first end and by the anode thereof to the midpoint in order to receive each homopolar component; the second diode being connected by the anode thereof to the second end and by the cathode thereof to the midpoint in order to receive each homopolar component; and the connection module being further configured to connect the first power supply terminal to the first end and the second power supply terminal to the second end.

27. The installation according to claim 26, wherein the reference point is connected to a terminal of a respective DC cell.

28. The installation according to claim 9, wherein each electrical load is an electric motor including a rotor and a stator, the windings connected in star connection being the windings of the stator.

29. The installation according to claim 28, wherein the electric motor is a synchronous motor with a wound rotor, called wound excitation, and the auxiliary power supply system being then preferentially configured to additionally supply the wound rotor of the synchronous motor.
